(19) United States
(12) Patent Application Publication
(10) Pub. No.: US 2008/0103831 A1
(43) Pub. Date: May 1, 2008

(54) Disease Management Information System

(75) Inventors: Vickilyn Spiotta, Shaker Heights, OH (US); Rajiv Prasad, Bryn Mawr, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/872,094

(22) Filed: Oct. 15, 2007

Related U.S. Application Data
(60) Provisional application No. 60/829,561, filed on Oct. 16, 2006.

(51) Int. Cl. G06Q 50/00

(52) U.S. Cl. 705/3

(57) ABSTRACT

A system automatically, provides a clinician with cancer specific staging criteria in response to a user selected cancer diagnosis name, calculates a stage of the disease in response to selection of particular staging criteria and associates treatments and clinical documentation with the cancer diagnosis and stage. A disease management information system includes a repository of information associating a combination of multiple disease progression indicators of a particular disease with an indicator identifying a particular stage of the particular disease. A data processor uses the repository in automatically determining a stage of a disease in a particular patient in response to receiving data identifying multiple disease progression indicators of the particular patient. The data processor stores data identifying the disease stage in a record associated with the particular patient for access by multiple healthcare workers at different locations.

This is a non-provisional application of provisional application Ser. No. 60/829,561 filed Oct. 16, 2006, by V. Spiotta et al.

### FIELD OF THE INVENTION

This invention concerns a disease management information system involving automatically determining a stage of a disease in a patient in response to receiving data identifying disease progression indicators of the patient.

### BACKGROUND OF THE INVENTION

In medical treatment and diagnosis of a patient it is necessary to associate a clinical cancer diagnosis with a progression stage and one of multiple different cancer types as determined by the American Joint Committee on Cancer (AJCC). Known systems involve performing this operation manually. In such known systems a clinician consults reference material for example an AJCC manual. This AJCC manual is often kept in a clinician's office and is not readily widely available. Known computerized systems typically do not automatically store a calculated cancer stage of a patient and fail to automatically provide a clinician with appropriate staging criteria based on a cancer diagnosis. Known systems also fail to appropriately link a clinical cancer diagnosis name to AJCC compatible cancer types. A system according to invention principles addresses these deficiencies and related problems.

### SUMMARY OF THE INVENTION

A system automatically, provides a clinician with cancer specific staging criteria in response to a user selected cancer diagnosis name associated with an AJCC compatible cancer type, calculates a stage of the disease in response to selection of particular staging criteria and associated treatments and clinical documentation with the cancer diagnosis and stage. A disease management information system includes a repository of information associating a combination of multiple disease progression indicators of a particular disease with an indicator identifying a particular stage of the particular disease. A data processor uses the repository in automatically determining a stage of a disease in a particular patient in response to receiving data identifying multiple disease progression indicators of the particular patient. The data processor stores data identifying the disease stage in a record associated with the particular patient for access by multiple healthcare workers at different locations.

### BRIEF DESCRIPTION OF THE DRAWING

FIG. 1 shows a disease management information system, according to invention principles.

FIG. 2 shows a flowchart of a process performed by a disease management information system, according to invention principles.

FIG. 3 shows a flowchart of a process for acquiring disease stage information performed by a disease management information system, according to invention principles.

FIGS. 4 and 5 show a flowchart of a process performed by a disease management information system in automatically determining a disease stage, according to invention principles.

FIGS. 6, 7 and 8 shows User Interface display images provided by a disease management information system supporting associating a cancer type with a diagnosis name and automatically calculating and storing an associated cancer stage, according to invention principles.

FIG. 9 shows a spreadsheet of stage data used in disease management information system in automatically determining a disease stage, according to invention principles.

FIG. 10 shows a flowchart of a process for determining and using disease stage information performed by disease management information system, according to invention principles.

### DETAILED DESCRIPTION OF THE INVENTION

A system automatically, provides a clinician with cancer specific staging criteria in response to a user selected cancer diagnosis name associated with an American Joint Committee on Cancer (AJCC) compatible cancer type, calculates a stage of the disease in response to selection of particular staging criteria and automatically associates treatments and clinical documentation with the cancer diagnosis and stage. Upon installation of an Oncology information System (OIS), for example, cancer diagnosis types are provided as defined by the AJCC. A user defines cancer diagnosis names associated with cancer types. A clinician is provided with candidate cancer specific staging criteria based on the cancer diagnosis name chosen. In response to selection of the criteria, the system automatically calculates the stage of the disease. In response to saving the cancer diagnosis name and stage in the OIS, treatments and clinical documentation are advantageously automatically associated with cancer diagnosis and stage.

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters and providing resulting output data and/or parameters. A user interface (UI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A workflow processor, as used herein, processes data to determine tasks to add to a task list, remove from a task list or modifies tasks incorporated on, or for incorporation on, a task list. A task list is a list of tasks for performance by a worker or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition.

A Workflow Management System is a software system that manages processes. It includes a process definition function that allows users to define a process that should be followed, an Event Monitor, which captures events from a Healthcare Information System and communicates the results to the Workflow Management System. A processor in the Management System tracks which processes are running, for which patients, and what step needs to be executed next, according to a process definition. The Management System includes a procedure for notifying clinicians of a task to be performed, through their worklists (task lists) and a procedure for allocating and assigning tasks to specific users or specific teams. A document or record comprises a compilation of data in electronic form and is the equivalent of a paper document and may comprise a single, self-contained unit of information.

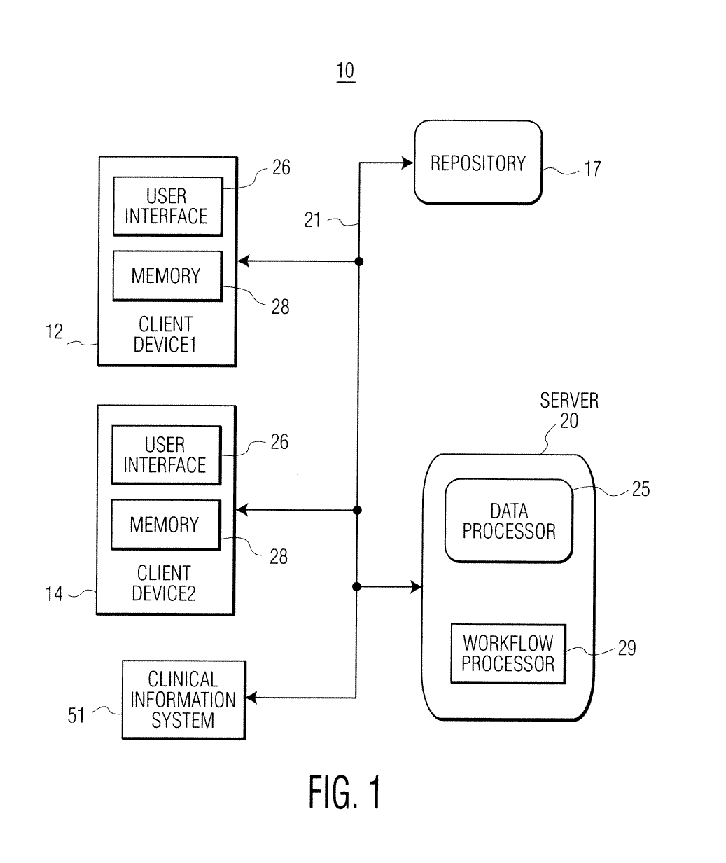

FIG. 1 shows disease management information system 10 including client devices (workstations) 12 and 14, repository 17, clinical information system 51 and server 20 inter-communicating via network 21. User interface 26 in workstation 12 provides data representing at least one display image enabling a user to associate a disease type with one or more different clinical diagnoses and associated corresponding clinical diagnoses names. At least one repository 17 includes information associating a combination of multiple disease progression indicators of a particular disease with an indicator identifying a particular stage of the particular disease and a corresponding user determined clinical diagnosis name. Data processor 25 uses repository 17 in automatically determining a stage of a disease in a particular patient in response to receiving data identifying multiple disease progression indicators of the particular patient. Data processor 25 also stores data identifying the disease stage and the corresponding user determined clinical diagnosis name in a record in repository 17 associated with the particular patient for access by multiple healthcare workers at different locations.

System 10 enables a user to associate a clinical cancer diagnosis with cancer types as provided by the American Joint Committee on Cancer. System 10 automatically presents a clinician with appropriate candidate staging criteria based on clinician choice of cancer diagnosis for a patient. System 10 automatically generates a link between cancer diagnosis and appropriate staging criteria allowing information to be presented to a clinician once a diagnosis has been chosen. A clinician chooses appropriate staging criteria for a specific diagnosis and system 10 automatically calculates the stage of the cancer diagnosis based on AJCC compatible XML files based on cancer types. An XML file exists for each cancer type that contains a stage grouping for a specific cancer type. A stage grouping contains a specific combination of staging criteria (for example Tumor, Nodes, and Metastasis values) and the stages these combinations create.

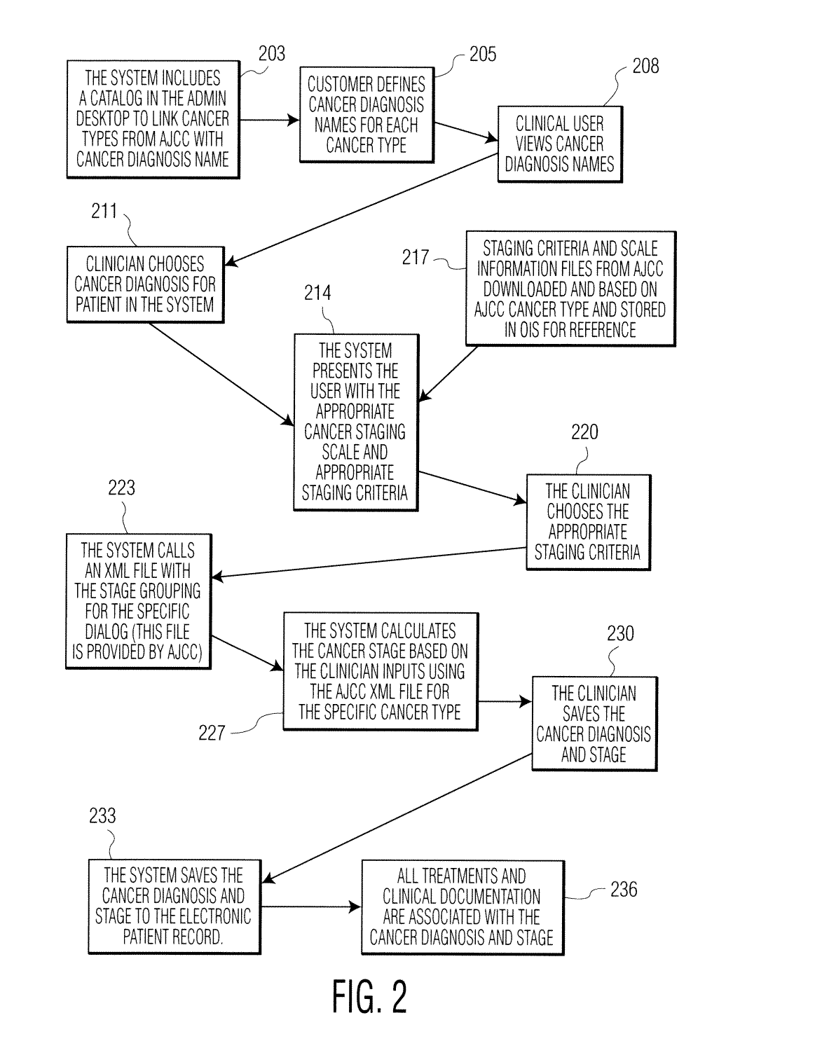

FIG. 2 shows a flowchart of a process performed using disease management information system 10. In step 203 disease catalog data is incorporated in an information system and is presented on workstation 12 for use in associating AJCC compatible cancer types with cancer diagnosis names. A user determines cancer diagnosis names for each cancer type in step 205 which are viewed by a clinician in step 208. The clinician in step 21 selects a cancer diagnosis for a patient and in step 214, data processor 25 presents the clinician with appropriate cancer staging scale and appropriate staging criteria. In step 217 AJCC compatible staging criteria and scale information is downloaded in files and stored in the information system (e.g., an OIS) in response to AJCC compatible cancer type. The clinician selects appropriate staging criteria in step 220 and in step 223 data processor 25 acquires an AJCC compatible file (e.g., an XML file) with a stage grouping for specific staging criteria. In step 227, data processor 25 automatically calculates a cancer stage in response to clinician inputs using the acquired AJCC compatible file for the specific cancer type. In step 230 the clinician saves the cancer diagnosis and stage information in repository 17. System 10 stores the cancer diagnosis name and stage in a patient record in step 233 and the cancer diagnosis name and stage are associated with corresponding treatments and documentation in step 236.

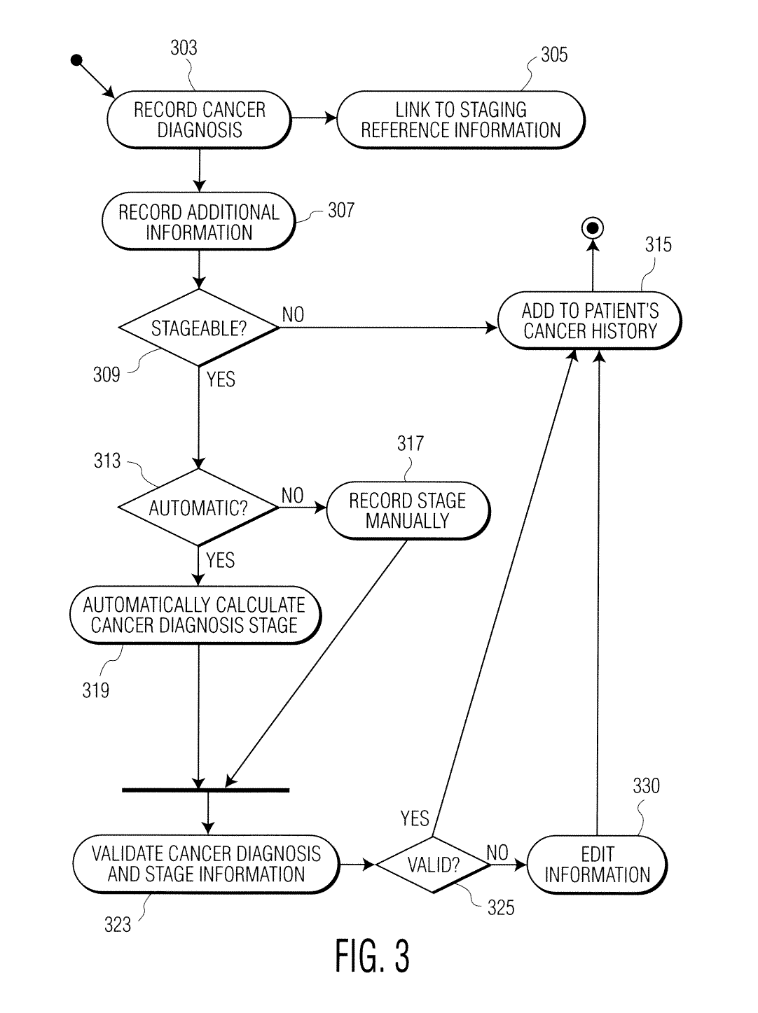

FIG. 3 shows a flowchart of a process for acquiring disease stage information performed by a disease management information system. System 10 creates a link to staging reference information in step 305 in response to a user in step 303 initiating storage of a record indicating an associated cancer diagnosis. System 10 prompts a user for additional cancer diagnosis related information via image display messages in step 307 and determines if the diagnosis has a stage in step 309. In response to a determination the diagnosis has no determinable stage in step 309, the diagnosis information is stored in a patient record in repository 17 in step 315. If the cancer diagnosis is determined to have a stage, system 10 initiates automatic or manual stage determination in step 313. Specifically, system 10 automatically determines a cancer progression stage in step 319 or acquires manual stage identification data in step 317 and in step 323 system 10 validates the cancer diagnosis and associated stage information. In response to an invalidity determination in step 325, a user is prompted to edit the information in step 330. In response to a determination the diagnosis and associated stage information is valid in step 325, it is stored in a patient record in repository 17 in step 315.

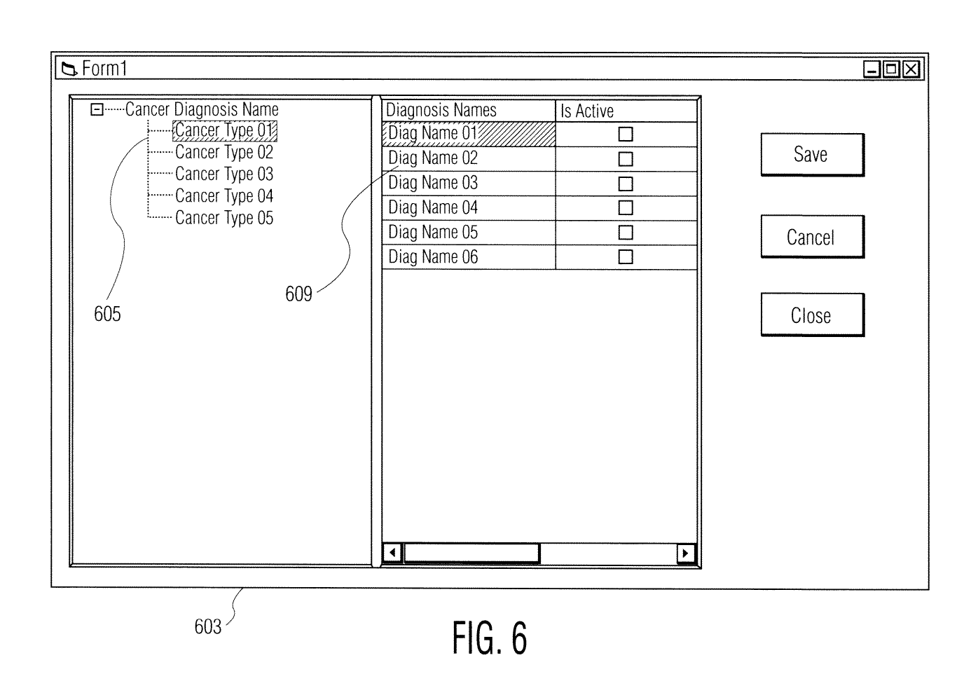

FIGS. 6, 7 and 8 shows User Interface display images provided by a disease management information system supporting associating a cancer type with a diagnosis name and automatically calculating and storing an associated cancer stage. Automatically generated display image 603 of FIG. 6 enables a user to associate one of multiple cancer types 605 with a selected one of multiple diagnosis names 609. image display 603 and associated executable procedures enables a user to link an AJCC compatible cancer type to one of multiple user determined cancer diagnosis names for an individual cancer type.

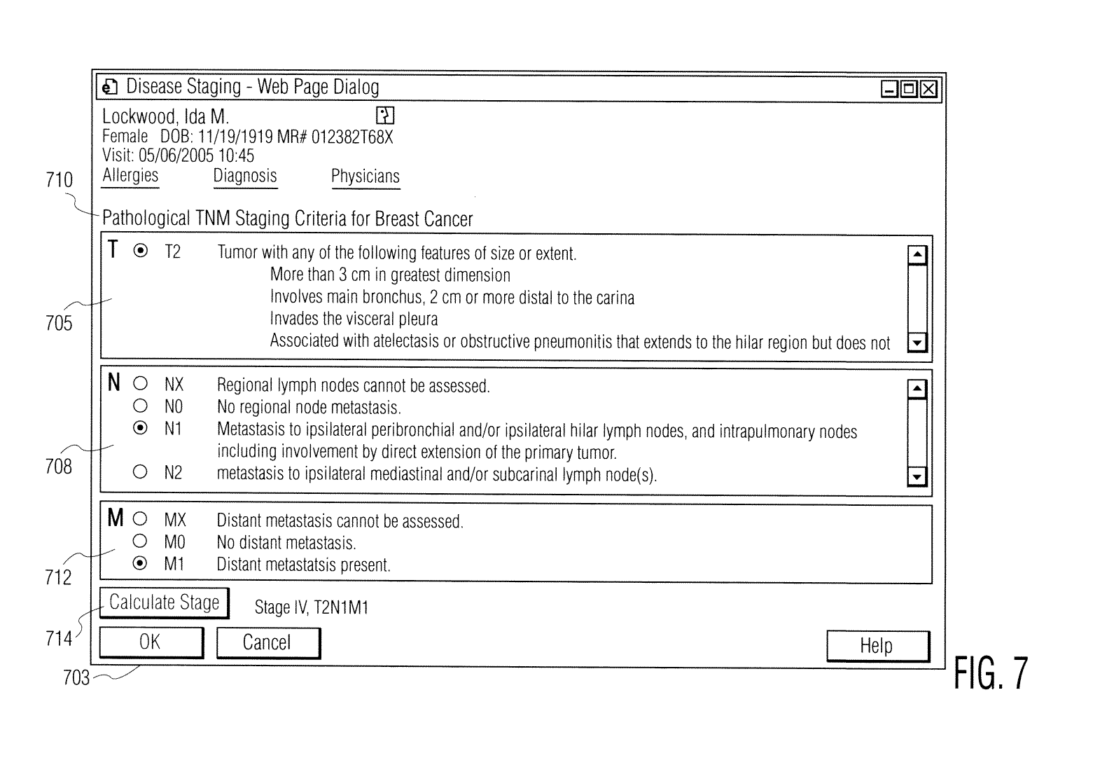

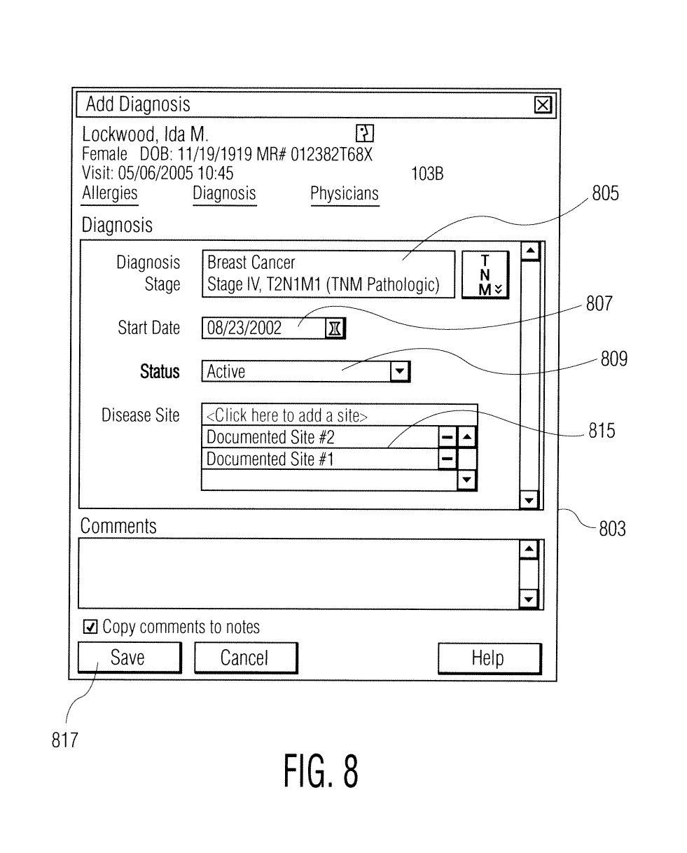

Image display 703 of FIG. 7 enables a user to initiate automatic calculation of a cancer diagnosis stage (e.g., for breast cancer). A clinician selects breast cancer as indicated in item 710 and is presented with image display 703 including appropriate staging criteria. A clinician selects appropriate Tumor (T) 705, Nodes (N) 708, Metastasis (M) 712 and upon initiating stage calculation via button 714 system 10 automatically calculates the stage. In response to selection of button 714, image display 803 of FIG. 8 is displayed on workstation 12 (FIG. 1). Image display 803 presents diagnosis name and calculated stage 805, first diagnosis start date 807, disease status 809 and one or more documented anatomical disease sites 815. A user initiates storage of the cancer diagnosis name and stage by selection of button 817. Once the cancer diagnosis and stage are stored, the cancer diagnosis name and stage are viewable in a display image on workstation 12 by a clinician with appropriate security privileges. System 10 advantageously enables a user to link a clinical cancer diagnosis name to an AJCC (or other) compatible cancer type and provides a clinician with appropriate staging criteria by calculating a cancer stage based on clinician choice of staging criteria. System 10 further stores this information and provides a means for a user to define a clinical cancer diagnosis name for each cancer type as defined by the AJCC and enables a user to view clinical cancer diagnoses and associated cancer types in a single display image.

System 10 advantageously allows a clinician to view a clinical cancer diagnosis and automatically determines a stage of the cancer diagnosis. The American Joint Committee on Cancer provides cancer type data which provides a staging scale and criteria for cancers associated with a specific type. For example for a cancer type of “Colon and Rectum”, a clinical diagnosis may be colon cancer, rectal cancer, or colorectal cancer. Therefore a user, via user interface 26, is able to initiate determination of clinical cancer diagnosis names for cancer types as defined by the AJCC. System 10 advantageously facilitates clinician performance of cancer staging. Thereby, a clinician no longer has to refer to an AJCC manual and system 10 calculates a patient cancer stage in response to entered criteria. The calculated stage is a first step in determining appropriate therapy for a given patient. Treatments and clinical documentation are also advantageously automatically associated with the cancer diagnosis and stage.

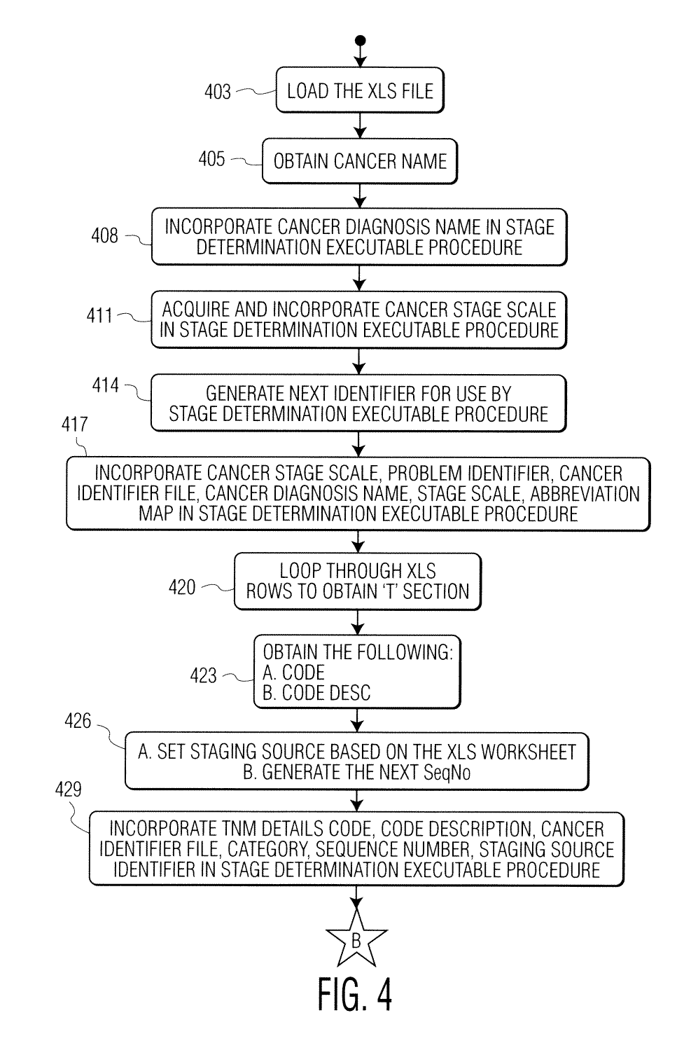

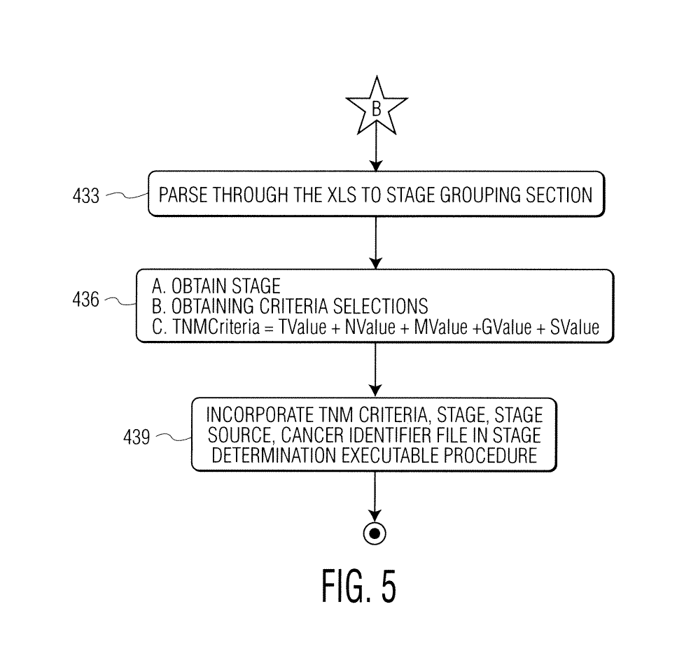

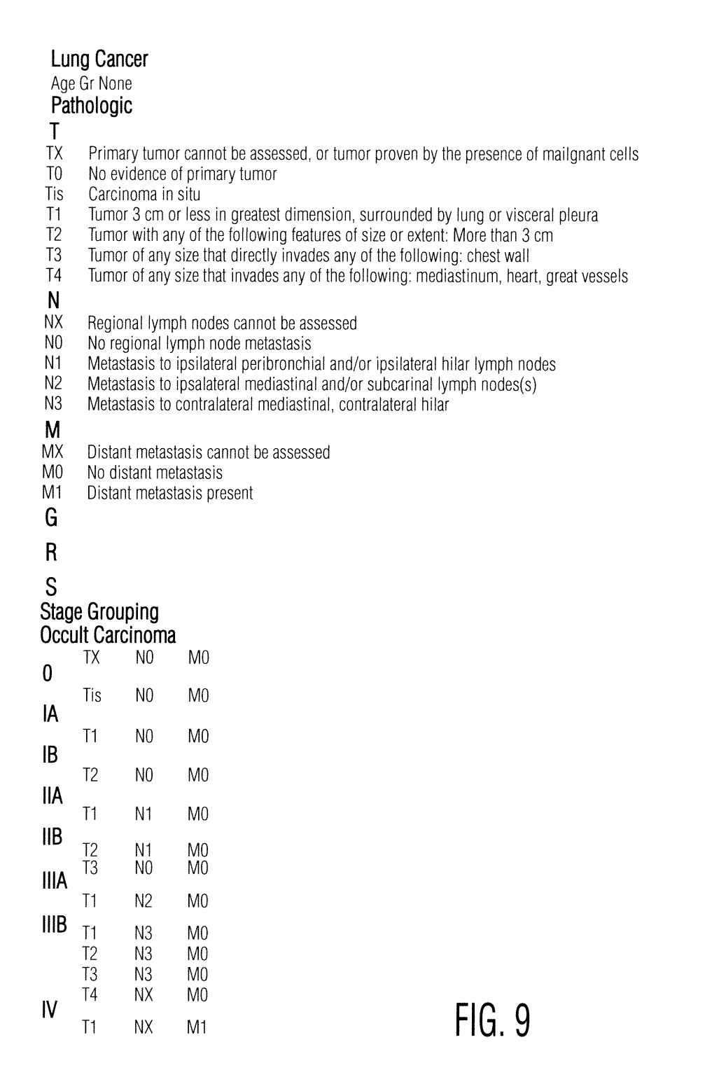

FIGS. 4 and 5 show a flowchart of a process performed by a disease management information system in automatically determining a disease stage. Data processor 25 in step 403 loads an excel spreadsheet incorporating cancer stage information including Tumor (T), Node (N) and Metastases (M) data as illustrated in part in FIG. 9. The remaining steps of FIGS. 4 and 5 are performed for each loaded spreadsheet of multiple loaded spreadsheets. In step 405 a cancer diagnosis name is acquired for use by a stage determination executable procedure employed by data processor 25 in step 408. A diagnosis stage scale (a TNM scale here as shown within FIG. 9) that is appropriate for the acquired cancer diagnosis name is acquired in step 411 from repository 17. The stage determination executable procedure in step 414 generates an identifier linked to the cancer diagnosis name for use to increment and iteratively process further cancer diagnosis names. In step 417, data processor 25 provides inputs including cancer stage scale identifier, problem identifier, cancer identifier file, cancer diagnosis name, stage scale and abbreviation map (identifying abbreviations in the nomenclature used), to the stage determination executable procedure.

The stage determination executable procedure in step 420 parses the excel spreadsheet containing cancer stage data loaded in step 403 to obtain the Tumor (T) section data. In step 423, the stage determination executable procedure acquires a code (e.g., an ICD9 code) and code description representing the cancer diagnosis. Further, in step 426 the stage determination executable procedure determines a source of staging criteria in the loaded spreadsheet of cancer stage data and generates a next sequence number for use in iterating through the staging data e.g., N and M sections. In step 429 the stage determination executable procedure incorporates a TNM details code, code description, cancer identifier file, category, sequence number and staging source identifier. Steps 420, 423, 426 and 429 are repeated for different sections of spreadsheet data such as clinical and pathologic stage data sections and included N, M, G and S portions if applicable in the cancer stage data. The stage determination executable procedure, in step 433 (FIG. 5) parses the cancer stage data spreadsheet to find a desired stage group section (e.g., T, N or M section) and in step 436 determines a cancer stage, selected cancer stage criteria and TNM criteria comprising a T value, N value, M value, G value and S value, for example. In one example, the stage determination executable procedure determines a stage as IIA from the spreadsheet data in response to T, N, M values (disease progression indicators) of T1, N1 and M0 respectively as indicated in Table I below comprising an excerpt from the FIG. 9 spreadsheet data. Similarly, the stage determination executable procedure determines a stage as IIIA from the spreadsheet data in response to T, N, M values of T1, N2 M0, T2, N2 M0, T3, N1 M0 or T3, N2 M0.

TABLE I
IIA

| | | |
|---|---|---|
| T1 | N1 | M0 |

IIIA

| | | |
|---|---|---|
| T1 | N2 | M0 |
| T2 | N2 | M0 |
| T3 | N1 | M0 |
| T3 | N2 | M0 |

The stage determination executable procedure, in step 439 stores the TNM criteria, stage and stage criteria. Steps 436 and 439 are repeated for different sections of spreadsheet data such as clinical and pathologic stage data sections and the process of FIGS. 4 and 5 ends.

The system enables a user to determine a clinically relevant name for a cancer type and to easily determine and document a stage of a patient cancer diagnosis using provided appropriate staging criteria. A clinician selects appropriate stag values (e.g. TNM values as shown in FIG. 9 spreadsheet data) and data processor 25 calculates the cancer diagnosis stage. The cancer diagnosis stage is stored in repository 17 so multiple clinicians working with a patient with appropriate security privileges have ready access to this information. In another embodiment, a clinician determines a patient has a cancer diagnosis. In response to a clinical cancer diagnosis being entered in system 10, a clinician is presented on workstation 12 with appropriate staging criteria based on AJCC compatible cancer types. There is a linkage in repository 17 between the AJCC cancer type and the clinical cancer diagnosis name supporting clinician use of the clinical cancer diagnosis name. System 10 advantageously associates a cancer diagnosis and stage with treatments and clinical documentation in repository 17.

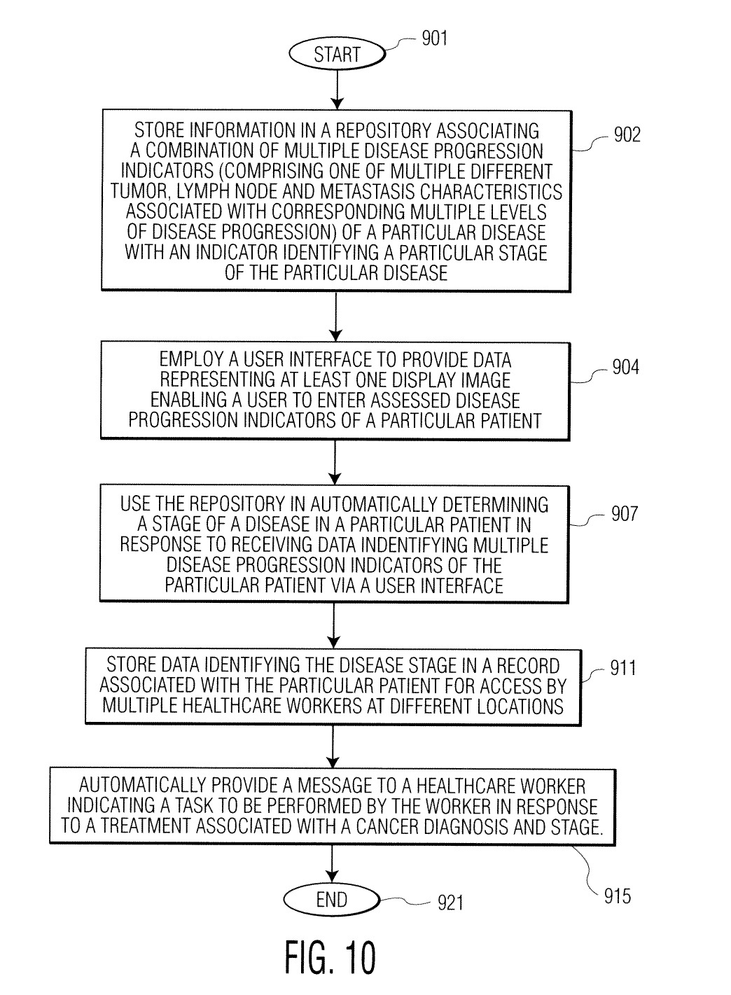

FIG. 10 shows a flowchart of a process for determining and using disease stage information performed by a disease management information system. The steps of FIG. 10 may be performed automatically. In step 902 following the start at step 901, system 10 (FIG. 1) stores user determinable information in repository 17 associating a combination of multiple disease progression indicators (staging criteria) of a particular disease with an indicator identifying a particular stage of the particular disease, a disease type and a corresponding user determined clinical diagnosis name. The disease progression indicators comprise one of multiple different Tumor, Lymph Node and Metastasis characteristics, for example, associated with corresponding multiple levels of disease progression. Repository 17 stores XML compatible data representing the combination of the multiple progression indicators of the particular disease associated with the indicator identifying the particular stage of the particular disease. Information in repository 17 associates a cancer diagnosis and stage with treatments and clinical documentation.

User interface 26 in step 904 provides data representing at least one display image enabling a user to enter assessed disease progression indicators of a particular patient. The at least one display image enables a user to associate a disease type with one or more different user determinable clinical diagnoses and associated corresponding clinical diagnoses names. The at least one display image prompts a user with candidate disease progression indicators selectable to provide the received data identifying the multiple disease progression indicators of the particular patient in response to user entered data identifying a diagnosis of the particular patient. In step 907 data processor 25 uses repository 17 in automatically determining a stage of a disease in a particular patient in response to receiving data identifying multiple disease progression indicators of the particular patient via user interface 6. Data processor 25 automatically determines a stage of a disease in a particular patient by comparing the multiple disease progression indicators of the particular patient with the combination of the multiple disease progression indicators, associated with a particular stage of a particular disease, derived from repository 17. Data processor 25 automatically calculates a stage of a disease in a particular patient by determining whether data representing the multiple disease progression indicators of the particular patient comprise one or more predetermined combinations of the multiple disease progression indicators, associated with a particular stage of a particular disease, derived from repository 17.

In step 911 data processor 25 stores data identifying the disease stage for a disease having a clinical diagnosis name determined using the user determinable information. Data processor 25 also stores corresponding user determined clinical diagnosis name in a record associated with the particular patient for access by multiple healthcare workers at different locations. Data processor 25 automatically associates treatment information and clinical documentation with the identified cancer diagnosis disease stage of the particular patient using repository 17. Data processor 25 automatically stores at least one of, (a) the associated treatment information and clinical documentation and (b) a pointer to the associated treatment information and clinical documentation, in a record associated with the particular patient. Workflow processor 29 in step 915 automatically provides a message to a healthcare worker indicating a task to be performed by the worker in response to a treatment associated with a cancer diagnosis and stage. The process of FIG. 10 terminates at step 921.

The systems and processes of FIGS. 1-10 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. System 10 enables a user to determine a clinically relevant name for a cancer type and to easily determine and document a stage of a patient cancer diagnosis using provided appropriate staging criteria and associates the cancer diagnosis and stage with treatments and clinical documentation in repository 17. The processes and applications may in alternative embodiments, be located on one or more (e.g., distributed) processing devices accessing a network linking the elements of FIG. 1. Further, any of the functions and steps provided in FIGS. 1-10 may be implemented in hardware, software or a combination of both and may reside on one or more processing devices located at any location of a network linking the elements of FIG. 1 or another linked network including the Internet.

What is claimed is:

1. A disease management information system, comprising:
a repository of information associating a combination of a plurality of disease progression indicators of a particular disease with an indicator identifying a particular stage of said particular disease; and
a data processor for,
using said repository in automatically determining a stage of a disease in a particular patient in response to receiving data identifying a plurality of disease progression indicators of said particular patient and
storing data identifying said disease stage in a record associated with said particular patient for access by a plurality of healthcare workers at different locations.

2. A system according to claim 1, including
a repository of user determinable information associating a disease type with a clinical diagnosis name and
said data processor stores data identifying said disease stage for a disease having a clinical diagnosis name determined using said user determinable information wherein
said data processor automatically determines a stage of a disease in a particular patient by comparing said plurality of disease progression indicators of said particular patient with said combination of said plurality of disease progression indicators, associated with a particular stage of a particular disease, derived from said repository.

3. A system according to claim 2, wherein
said data processor automatically calculates a stage of a disease in a particular patient by determining whether data representing said plurality of disease progression indicators of said particular patient comprise one or more predetermined combinations of said plurality of disease progression indicators, associated with a particular stage of a particular disease, derived from said repository.

4. A system according to claim 1, wherein
said disease progression indicators are staging criteria.

5. A system according to claim 1, including
a user interface providing data representing at least one display image for prompting a user with candidate disease progression indicators selectable to provide said received data identifying said plurality of disease progression indicators of said particular patient in response to user entered data identifying a diagnosis of said particular patient.

6. A system according to claim 1, wherein
said data processor automatically associates treatment information and clinical documentation with said identified disease stage of said particular patient.

7. A system according to claim 6, wherein
said data processor automatically stores at least one of, (a) said associated treatment information and clinical documentation and (b) a pointer to said associated treatment information and clinical documentation, in a record associated with said particular patient.

8. A system according to claim 1, wherein
said repository stores XML compatible data representing said combination of said plurality of disease progression indicators of said particular disease associated with said indicator identifying said particular stage of said particular disease.

9. A system according to claim 1, wherein
said disease progression indicators comprise one of a plurality of different Tumor characteristics associated with a corresponding plurality of levels of disease progression.

10. A system according to claim 9, wherein
said disease progression indicators comprise one of a plurality of different Lymph Node characteristics associated with a corresponding plurality of levels of disease progression and
said disease progression indicators comprise one of a plurality of different Metastasis characteristics associated with a corresponding plurality of levels of disease progression.

11. A system according to claim 1, wherein
said repository of information associates a cancer diagnosis and stage with treatments and clinical documentation and
said data processor associates a cancer diagnosis and stage of a patient with treatments and clinical documentation using said repository.

12. A system according to claim 11, including
a workflow processor for automatically providing a message to a healthcare worker indicating a task to be performed by said worker in response to a treatment associated with a cancer diagnosis and stage.

13. A disease management information system, comprising:
a user interface providing data representing at least one display image enabling a user to associate a disease type with one or more different clinical diagnoses and associated corresponding clinical diagnoses names;
at least one repository of information associating a combination of a plurality of disease progression indicators of a particular disease with an indicator identifying a particular stage of said particular disease and a corresponding user determined clinical diagnosis name; and
a data processor for,
using said repository in automatically determining a stage of a disease in a particular patient in response to receiving data identifying a plurality of disease progression indicators of said particular patient and
storing data identifying said disease stage and said corresponding user determined clinical diagnosis name in a record associated with said particular patient for access by a plurality of healthcare workers at different locations.

14. A system according to claim 13, wherein
said data processor automatically determines a stage of a disease in a particular patient by comparing said plurality of disease progression indicators of said particular patient with said combination of said plurality of disease progression indicators, associated with a particular stage of a particular disease, derived from said repository.

15. A system according to claim 13, wherein
said at least one repository stores XML compatible data representing said combination of said plurality of disease progression indicators of said particular disease associated with said indicator identifying said particular stage of said particular disease.

16. A system according to claim 13, wherein
said at least one display image enables a user to associate a disease type with one or more different user determinable clinical diagnoses and associated corresponding clinical diagnoses names.

17. A disease management information system, comprising:
a repository of information associating a combination of a plurality of disease progression indicators of a particular disease with an indicator identifying a particular stage of said particular disease, said disease progression indicators comprise one of a plurality of different Tumor, Lymph Node and Metastasis characteristics associated with a corresponding plurality of levels of disease progression;
a user interface providing data representing at least one display image enabling a user to enter assessed disease progression indicators of a particular patient;
a data processor for,
using said repository in automatically determining a stage of a disease in a particular patient in response to receiving data identifying a plurality of disease progression indicators of said particular patient via said user interface and
storing data identifying said disease stage in a record associated with said particular patient for access by a plurality of healthcare workers at different locations.

18. A system according to claim 17, wherein
said at least one display image enables a user to associate a disease type with one or more different user determinable clinical diagnoses and associated corresponding clinical diagnoses names.
